(19) United States
(12) Patent Application Publication
(10) Pub. No.: US 2007/0245862 A1
(43) Pub. Date: Oct. 25, 2007

(54) Magazine fed bit-changing combination tool

(76) Inventors: Nelson Gonzalez, Coconut Creek, FL (US); Michael Plucinski, Tampa, FL (US); Thor Stefan Arnoldsson, Ft. Lauderdale, FL (US); Jeremy E. Crowell, Boca Raton, FL (US)

Correspondence Address: William R. Trueba, Jr.;Kluger, Peretz, Kaplan & Berlin, P.L., Miami Center - 17th Floor, 201 South Biscayne Boulevard, Miami, FL, 33131, US

(21) Appl. No.: 11/408,439

(22) Filed: Apr. 21, 2006

(51) Int. Cl. B25B 23/00; B25G 1/08

(52) U.S. Cl. 81/439; 81/490

(57) ABSTRACT

A self-loading bit driver tool has a handle generally defining a predetermined axis. A support member, slidably mounted on the handle, moves generally parallel to the axis from proximate to remote positions. Bit storage—a cartridge, cassette or cylinder—stores a number of driver bits and is removably mounted on the support member and adjustably located at its remote end so as to selectively and successively place each stored driver bit along the is of that member. A barrel downstream of the support member and a push rod permanently connected to the handle move along with the member and receive and support the bit driver while the tool is being used. When the support member is moved to a proximate position, a chosen driver bit can be moved from bit storage into the barrel, or later returned to bit storage by means of a magnetic element.

### CROSS-REFERENCE TO RELATED APPLICATION

The present application claims priority to U.S. provisional patent application no. 60/673,159 filed Apr. 20, 2005. The entire disclosure of U.S. provisional patent application no. 60/673,159 is incorporated herein by reference.

### FIELD OF THE INVENTION

This invention generally relates to hand tools, and, more specifically, to an automatically loading bit driver that transfers bits from a storage magazine, cartridge, cassette or cylinder to an operative barrel or bit holder during use.

### BACKGROUND OF THE INVENTION

Screwdrivers that utilize individual driver bits have become very popular and are in widespread use. The popularity of these tools is in no doubt at least in part due to the fact that a single handle can be used to drive many different types of, fasteners, such as conventional screws having a straight slotted head, Philips screws, star fasteners, etc. Because the bits themselves are relatively small, a user has substantial flexibility in versatility in operating on many different types of fasteners without requiring individual screwdrivers or tools, each having its own handle.

While bit drivers have has become very popular, some types have some distinctive advantages. First, because of the large number of bits that are possible or available, manufacturers have provided storage devices, such as boxes, special containers, pouches, etc., for storing and typically displaying the numerous and various bits so that they can be easily and readily selected and used.

However, this typically requires the handling of many bits, which are often small and difficult to manipulate, especially in some working conditions. Also, there are some hand tools or drivers that are in the form of “n-in-one” drivers, such as “4-in-one,” “8-in-one,” etc. These tools generally involve a plurality of interfitting tubes or sleeves that come in different diameters so that they can be fitted one within the other and telescope in such a way that one driver bit can be positioned in an operative position by selectively orienting the various sleeves to expose the desired bit. However, this involves, for the most part, teal and error, as the bits are all concealed except for the one that is exposed. Finding the required bit can be time-consuming and somewhat frustrating. In addition, there is no real or effective way to store the bits in any organized fashion as the sleeves are frequently interchanged and a user who needs a Philips driver bit cannot quickly introduce, without trial and error, the appropriate bit and size for immediate use.

### OBJECTS OF THE INVENTION

The following section of the written description describes some of the objects of the present invention, but the section is not exhaustive of all of invention's objects.

It is an object of the present invention to provide an automatically loading bit driver that overcomes the above and other problems inherent in prior art bit drivers.

It is another object of the invention to provide an automatically loading bit driver that is simple in construction and economical to manufacture.

It is still another object of the invention to provide an automatically loading bit driver as suggested above that is convenience to use.

It is yet another object of the invention to provide an automatically loading bit driver that allows convenient and almost instantaneous loading of a desired bit.

It is a further object of the invention to provide an automatically loading bit driver that avoids the need to manually handle individual bits, thereby preventing inadvertent loss of such bits.

It is still a further object of the invention to provide an automatically loading bit driver as in the previous object that can be used with great ease and a minimum of effort.

### SUMMARY OF THE INVENTION

In order to achieve the above objects, as well as others that will become apparent hereinafter, a self-loading bit driver tool in accordance with the present invention comprises a handle that generally defines a predetermined axis. A movable support member is mounted on said handle for movement along a direction generally parallel to said axis, between a proximate position closest to said handle and a remote position furthest from said handle. A bit storage member is provided for receiving and storing a plurality of driver bits, said bit storage member being removably supported on said movable support member and adjustably positionable in said remote position of said movable support member to selectively and successively position each of the stored driver bits along said predetermined axis.

A barrel is mounted on the remote side of the movable support member and is movable therewith and dimensioned to receive and support a driver bit during use of the tool. Actuating means is provided for moving a selected driver bit from said driver storage member into said barrel when said movable support member is moved into said proximate position and returning a driver bit within said barrel into said bit storage member when said movable support member is moved to said remote position.

In a presently preferred embodiment, the bit storage member is in the form of a magazine, transparent cartridge, cassette or cylinder, one that has the appearance of the rotating chamber of a revolver that holds the bits. The cylinder may be formed of a clear acrylic plastic so that the individual bits within the cylinder can be seen and quickly selected and loaded into an operative position in the barrel.

### BRIEF DESCRIPTION OF THE DRAWINGS

The subject matter which is regarded as the invention is particularly pointed out and distinctly claimed in the claims at the conclusion of the specification. The foregoing, and other objects, features, and advantages of the present invention are shown and described in the following detailed description of the preferred embodiments which should be viewed in conjunction with the accompanying drawings in which:

FIG. 1 is a side elevational view of an automatically loading bit driver in accordance with the present invention, shown with a driver bit loaded and the tool ready for use;

FIG. 2 is an exploded view of the bit driver shown in FIG. 1, showing all the component parts as well as au additional cartridge cassette or cylinder that can be stored within the handle of the tool;

FIG. 3 is an enlarged view of the handle shown. in FIG. 1 and also showing, in fragmented form, the push rod that serves as the actuator or mover of the driver bits;

FIG. 4 is a side elevational view of the end cap of the handle that is removable to obtain access to a cavity in which an additional cartridge, cassette or cylinder can be stored;

FIG. 5 is a side elevational view of the push rod shown in FIG. 2, also showing a fastener that may be used at one end thereof securing the push rod to the handle;

FIG. 5A is a front or end elevational view of the push rod shown in FIG. 5;

FIG. 6 is a top plan view of the movable support member shown in FIG. 2;

FIG. 7 is a side elevational view of the movable support member shown in FIG. 6;

FIG. 8 is a frontal perspective view of the movable support member shown in FIG. 2, showing some details within the cartridge-, cassette- or cylinder-receiving space;

FIG. 9 is a rear perspective view of the movable support member shown in FIG. 8;

FIG. 10 is a front elevational view of the remote wing or wall portion of the cradle shown in FIGS. 6 and 7;

FIG. 11 is a fragmented schematic representation of the magnetic head of the actuator, as it is seated in the proximate wing or wall portion of the support member shown in FIGS. 6 and 7;

FIG. 12 is a side elevational view of the barrel shown in FIG. 2;

FIG. 13 is an end elevational view of the barrel shown in FIG. 12;

FIG. 14 is a side elevational view of the cartridge, cassette or cylinder shown in FIG. 2 and also showing, in phantom outline, a central embedded magnet for retaining the bits in place and preventing the bits from inadvertently coming out of the cartridge, cassette or cylinder;

FIG. 15 is an end elevational view of the cartridge, cassette or cylinder shown in FIG. 14; and

FIGS. 16-19 are additional views of the cartridge, cassette or cylinder shown in FIGS. 14 and 15.

### DETAILED DESCRIPTION OF THE PREFERRED EMBODIMENTS

The present invention relates to hand tools, and, more specifically, to an automatically loading bit driver that transfers bits from a storage magazine, cartridge, cassette or cylinder to an operative barrel or bit holder during use.

It is important to note that the embodiments of the invention described below are only examples of some of the uses of the teachings described herein. In general, statements made in the specification do not limit any of the various claimed inventions. Moreover, some statements may apply to some inventive features but not to others. Unless otherwise indicated, singular elements may be in the plural and vice versa with no loss of generality. Similar reference numerals and letters represent similar components and system features throughout the drawings and the written description.

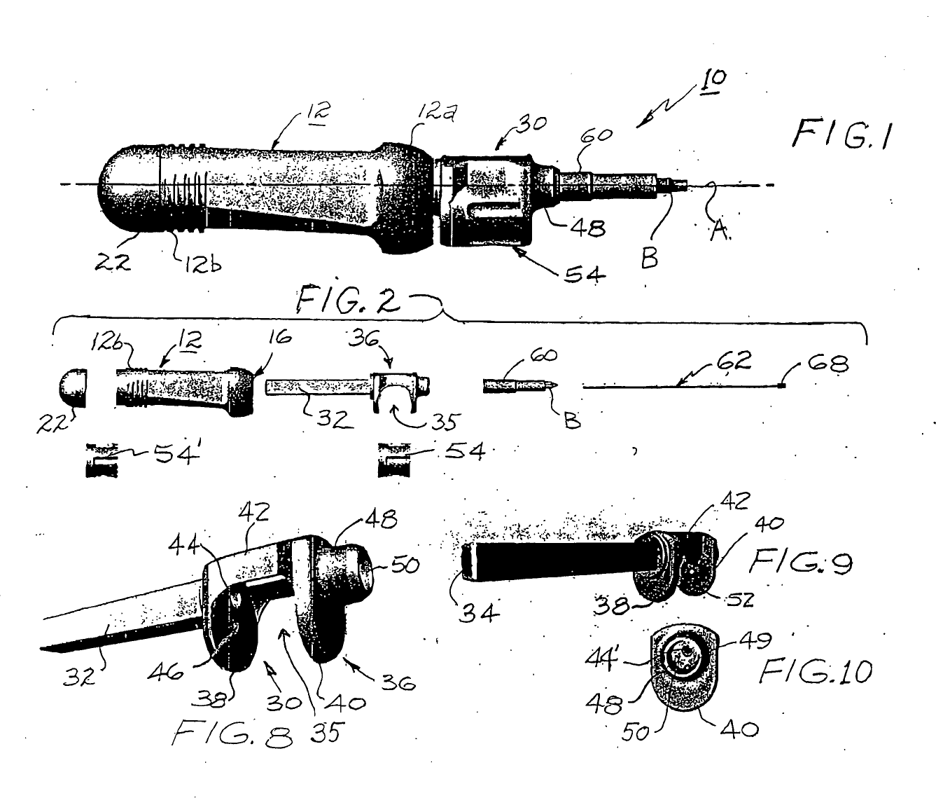

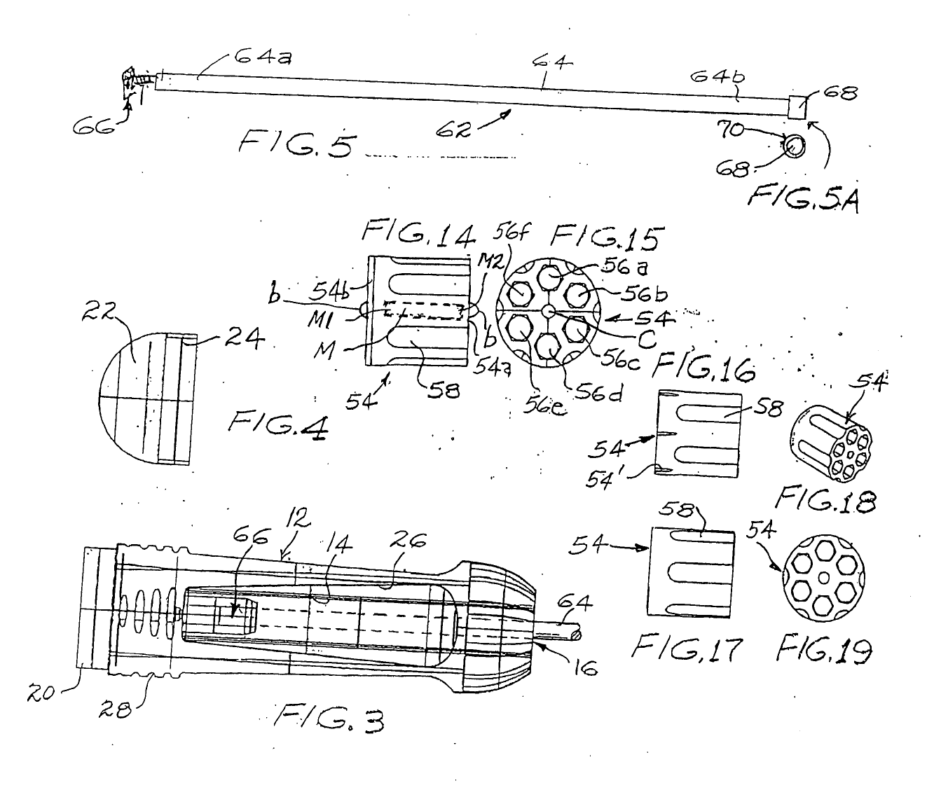

Referring now to the Figures, in which identical or similar parts are designated by the same reference numerals throughout, and first referring to FIG. 1, a self-loading bit driver tool is generally designated by the reference numeral 10.

The bit driver tool 10 includes a handle 12 that generally defines a predetermined axis A, which can be considered or described as the tool or driver is. As will become evident, this axis A is the axis about which the tool and a bit B rotate in the operative mode or when the tool is used. The handle is provided with a remote end 12a and proximate end 12b, these descriptions being from the vantage point of a user positioned to the left of the tool, as viewed in FIG. 1.

Referring to FIG. 3, the handle 12 includes an axial channel 14 defining an opening 16 at the remote axial end of the handle. The specific cross section of the channel 14 is not critical as long as the channel has a substantially uniform cross section the entire length thereof, for reasons that will be made evident below.

Referring to FIGS. 3 and 4, the handle 12 is advantageously provided at the proximate end 12b with a cavity for receiving a spare bit storage member of a type to be described. For this purpose, the proximate end of the handle 12 may advantageously be provided with an, external threaded region 20 and an end cap 22 may be provided with internal threads 24 so that the cap 22 may be removed to insert or withdraw a spare cartridge, cassette or cylinder and re-attached to the main body of the handle 12 to close the cavity.

The exterior configuration 26 of the handle 12 may be ergonomically designed to optimize the comfort of the user, and may be provided with surface texture or ribs 28 to facilitate gripping and minimize slippage when the user uses the tools or removes the cap 22.

A movable support member is generally designated by the reference numeral 30, which is mounted on the handle 12 for movement along a direction generally parallel to the axis A between a proximate position closest to the handle, as shown in FIG. 1, and a remote position furthest from the handle. While it is possible to mount the movable support member 30 on the handle 12 in any suitable or known way to achieve the objectives of the invention, in the presently preferred embodiment such movable support member 30 is slidably mounted on the handle 12. As indicated, the handle 12 includes an axial channel 14 that defines the opening 16 at the remote end of the handle. The movable support member 30 includes an elongate slide bar or rod 32 that is slidably receivable within the axial channel 14 for the movement of the movable support member 30 between the proximate and remote positions. The specific cross sectional configuration of the channel 14 and/or of the slide bar or rod 32 is not critical, as long as they are compatible and substantially uniform along their lengths so that the elongate bar or rod 32 can be received with little clearance and can slide in relation to the handle along the direction of the is A. The slide bar or rod 32 is provided with an elongate bore or channel 34 (FIG. 9) that extends the entire length of the bar or rod 32. For reasons that will become evident below, the dimensions and/or material selected for the bar or rod 32 are such as to optimize or enhance the strength of the bar or rod 32 so as to allow it to withstand the anticipated torques applied to it during use. Thus, while the bar or rod 32 is configured to axially slide in relation to the handle 12, they are configured, or structure is provided, so that rotation by the bar or rod about the axis in relation to the handle is prevented. In the illustrated embodiment, such common rotation is assured by the square cross sections of bar or rod and of the channel 14. However, other structural approaches may be used, even with round cross sections, as will be evident to those skilled in the art.

In the presently preferred embodiment, the movable support member 30 includes a cradle 36 on the remote end of the slide bar or rod 32, exposed exteriorly of the handle 12 in both the proximate and remote positions. As viewed in FIGS. 2 and 6-9, the cradle is mounted on the remote or rightmost end of the slide bar or rod 32, leaving the substantial length of the elongate slide bar or rod 32 to be received within the channel 14 for sliding movements relative to the handle.

The cradle 36 is dimensioned to releasably receive a bit storage member, to be describe. For this purpose, the cradle describes a chamber, space or compartment 35 having an opening for receiving and releasing a bit storage member by movements of the bit storage member in a direction generally transverse to the direction of the axis A. In the disclosed embodiment the chamber 35 is formed by two axially spaced walls or wings 38, 40 that are generally parallel to each other and arranged in planes substantially normal to the axis A. in the embodiment shown, the walls or wings 38, 40, are joined to each other by means of a bridge 42 that sets the spacing between the walls or wings, Since the bridge 42 only appears along the top of the cradle, as viewed in FIGS. 7 and 8, for example, it will be clear that the cradle 30 exhibits significant openings about a substantial circumferential portion thereof so that the interior chamber or space may be accessed either from the bottom or, to a great extent, even from the sides of the cradle. The resulting chamber 35 is provided with such opening dimensioned to allow a bit storage member to be easily inserted or removed from the chamber.

A bit storage member is generally designated by the reference numeral 54. It is in the form of a cartridge, cassette or cylinder for receiving and storing a plurality of driver bits B. The bit driver member is removably supported on the movable support member 30 and is adjustably positionable, in the remote position of the movable support member 30, relative to the handle 12, to selectively and successively position each of the stored driver bits B within the cylinder 54 along the axis A. Thus, the space 35 and the cartridge, cassette or cylinder 54 are configured so that the latter may be received within the former with little clearance but with sufficient clearance so that the cartridge, cassette or cylinder is movable into, out of and within the chamber 35. As best shown in FIGS. 14-19, the cartridge, cassette or cylinder 54 generally has the appearance of the rotating chamber of a revolver that holds cartridges. Thus, the bit storage member is generally in the form of a right circular cylinder having a remote axial end 54a and a proximate end 54b. The cylinder 54 is provided with a plurality with driver-bit-receiving bores 56a -56f that are substantially uniformly and equally angularly displaced from each other about a central point of symmetry C (FIG. 15).

According to a feature of the invention, the bit storage member 54 is rotatably mounted within the chamber 35. This can be done in any known or conventional way. In the illustrated embodiment, a ball detent mechanism may be used, one that consists of ball detent elements on the cradle and on the bit storage member or cylinder 54, such as the spring-loaded ball bearings on the cylinder 54 (FIG. 14).

Referring to FIG. 8, for example, a recess 46 maybe provided on the wall or wing 38, the same being true for the opposing interior surface of the wall or wing 40. Such opposing recesses 46 are illustrated in FIG. 7. When recesses are provided on the interior surfaces of the walls or wings 40, the spring-loaded balls b may be provided on the cylinder 54, at the central region C. Once spring-loaded, the balls are aligned with and snapped into the recesses 46 on the interior surfaces of the was or wings 38, 40, the balls snap into such recesses and provide pivoting points about which the cartridge, cassette or cylinder 54 may rotate about an is offset from axis A while locked in place or secured within the cradle 36. A suitable opening 44 is provided in the wall or wing 38 that is aligned with the channel 34 and the slide bar or rod 32, all of these being generally aligned with the axis A.

An important feature of the invention is that the driver is provided with an indexing mechanism for indexing the position of the bit storage member or cylinder 56 when a bit is moved to position aligned along or coextensive with the axis A. Any indexing mechanism may be used, as will be evident to those skilled in, the art. For example, a leaf spring (not shown) can be provided on the bridge 42 facing the chamber or space 35 and projecting into that chamber or space, for biased engagement with angularly spaced recesses or notches 54′ (FIG. 16) on the exterior surface of the cartridge 54. Any other known or conventional indexing means can also be used.

Referring to FIG. 10, the wall or wing 40 is likewise provided with an opening or aperture 44′ within an annular projection or neck 48 that defines a generally circular opening 50, as shown in FIGS. 8-10. Thus, when a desired bit B is intended to be used, the cartridge or cylinder 56 is rotated about the points 46 until the desired bit B is brought into a position in alignment with the openings 44 and, therefore, also with the opening 44′, all aligned with the axis A.

A barrel 60 is provided that is received within the cylindrical opening 50 of the movable support member. The barrel 60 is preferably fixedly attached to the wall or wing 40, as shown in FIG. 1, and is normally attached to the movable support member so that it is movable therewith. The barrel 60 has a remote end dimensioned to receive and properly support a bit driver B during use of the tool, as shown in FIG. 1, when the movable support member is in the fully retracted position as shown in FIG. 1.

An actuating member is provided, generally designated by the reference numeral 62 in FIGS, 2 and 5. The actuating member 62 is used for moving a selected driver bit B from the bit storage member or cylinder 54 into the barrel 60 when the movable support member is in the retracted position, as shown in FIG. 1. The actuating member 62 is, in the preferred embodiment, an elongate push rod 64 fixed at a proximate end 64a to the handle 12. At the remote end 64b the push rod is configured and dimensioned to pass through the movable support member 30, by passing through the openings 44 and 44′, as the support member 30 moves into the proximate or refracted position. At the remote end 64b, the push rod 64 is preferably provided with a magnet 68, the cross-sectional dimensions of which may be greater than the cross-sectional dimensions of the push rod 64. L FIG. 5, thus, the diameter of the circular magnet 68 is greater than the diameter of the push rod 64. However, a smaller magnet may be used that has the same or smaller diameter than that of the push rod, as long as all these constructions allow the remote end 64b to be at least partially received within the barrel 60.

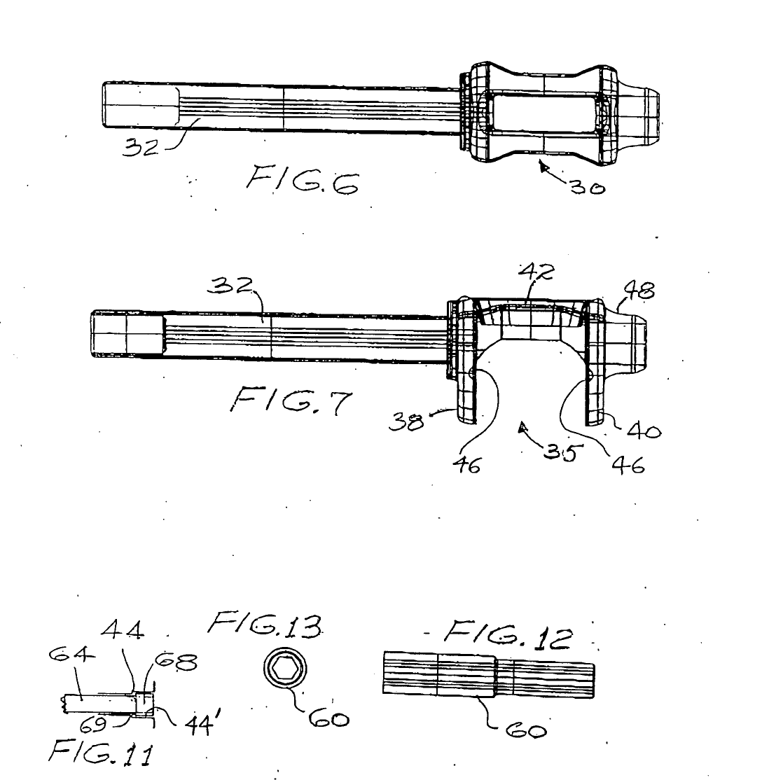

The magnet 68 may be secured to the remote end of the push rod in any known or conventional manner, and the magnet may be retained within an oversized annular sleeve or bushing or just crimped onto the magnet. By increasing the size of the magnet somewhat, a shoulder or lip 69 is provided. The dimensions of the opening 44 are selected to allow passage and sliding of the push rod 64 therethrough, but also to prevent the passage of the oversized magnet 68 beyond the wall or wing 38, Preferably, as suggested in FIG. 11, a recess or seat 44′ is provided in the wail or wing 38 in the region of the opening 44 that allows the magnet 68 to be received within the seat to clear the inside surface of the wall or wing. In this way, when the magnet is received within the seat, it does not project into the chamber or space 35 and interfere with the insertion or removal of the cartridge, cassette or cylinder 54.

As shown, the bores 56a -56f in the cylinder 54 are dimensioned to receive driver bits. The cross sections of the bores shown are hexagonal to correspond to the conventional cross sectional configurations of driver bits traditionally used in the industry. The bores 56a -56f are fully open at the remote surface 54a, while they are only partially open at the proximate end 54b. The openings at the proximate end 54b of each of the bores 56a -56f may only be sufficiently large to allow the push rod 64 and magnet 68 to be inserted therethrough to urge or push forward a driver bit from within the associated bore into the barrel 60. Making the openings on the proximate ends somewhat smaller or more restricted prevents the driver bits from being inadvertently passed through the opening 44 and drawn into the slide bar or rod 32. The driver bits, therefore, are only permitted to move from the cartridge, cassette or cylinder 56 into the barrel 60 and back into the cylinder, but cannot move rearwardly of the cylinder past the wall or wing 38. Preferably, a bar or rod magnet M is centrally embedded within the cylinder 54, as shown in phantom outline in FIG. 14 so that the magnet creates substantially equal magnetic fields within each of the bores 56a -56f. The ends of the magnet M can be polarized north (N) or south (S) at the respective ends M1, M2, the specific polarization being unimportant and not critical, as both options will retain the bits B within the cylinder 54 against inadvertently falling out of the bores during handling.

The push rod 64, as suggested, is fixed in relation to the handle 12. As best shown in FIG. 3, the push rod 64 maybe attached to the proximate end of the handle 12 in any conventional manner, such as by means of any suitable fasteners 66. The channel 34 in the slide bar or rod 32 is, as suggested, sufficiently large so that the push rod 64 can move freely axially therethrough along the axis A.

The bridge 42 is preferably provided with a cut-out 42a configured to accommodate and may receive an optional transparent window 42b. One feature of the invention is that the cartridge, cassette or cylinder 56 is formed of a transparent material, such clear acrylic plastic. As such, the cylinder and the window 42b male it possible to view the driver bit in the indexed position aligned with the axis A. This, then, is the position to which the desired driver bit intended to be used is moved. This bit is clearly and conveniently visible, and various bits can be moved by rotating the cylinder 56 until the desired driver bit is moved into the position visible through the window 42b.

The operation of the automatically loading bit driver 10 will now be described. While holding the handle 12 of the bit driver 10 in one hand, and gripping the barrel 60 in the other hand, the handle 12 and the barrel 60 are pulled in opposite directions from the initial condition shown in FIG. 1. This allows the push rod 64 to clear the chamber 35. These two members are pulled in opposite directions until the magnet 68 is received within the recess or counterbore forming part of the hole 44. Once the push rod and magnet have cleared and been withdrawn from the cradle 36, the bit driver can now be “loaded” by inserting a bit cartridge, cassette or cylinder 56 into the chamber 35, with the bit heads pointing toward the barrel 60. The cartridge, cassette or cylinder is then snapped into place by aligning a spring-loaded ball bearing in the cradle with locator holes in the cartridge. More specifically, the spring-loaded bearings at C on the cylinder are aligned with the recesses 46 in the walls or wings 38, 40. The cylinder or cartridge is now rotatably mounted and may be rotated to align the desired bit with the barrel or bit holder 60, by moving the desired bit into alignment and to be coextensive with the is A, proximate to the transparent window 42b, where the desired bit can now be viewed. The window 42b, the cradle 36 and the clear plastic cartridge allow for viewing of the desired bit in position, while a locator ball bearing or other detente mechanism in the cradle, and indents in the cartridge, allow for a perfect alignment of each bit in the cartridge with the barrel or holder.

The handle 12 is then pushed forward toward the barrel 60. This moves the push rod and supportive magnet 68 relative to the support member 30 and cradle 36, pushing the desired bit forward through the barrel 60 to emerge out of the end of the barrel and ready to use, as shown in FIG. 1.

To change bits, the handle 12 is moved away from the barrel 60, retracting the bit back into the cartridge by means of the magnetic attraction of the magnet on the bit. Once the push rod 64 is clear of the cartridge, the cartridge can then again be rotated to a desired new bit, and the process repeated.

The automatically loading bit driver in accordance with the present invention has a number of advantages over other multi-bit screwdriver systems. For example, multiple bits loaded into a cartridge allow for the quick changing of bit types and sizes using simple technology and steps or procedures (pull; twist; push), Cartridge bit storage allows for the quick changing of different screw head types. Cartridges allow for custom loading and use. The mounted cartridge and handle-stored cartridge allow for quick access to up to twelve different bits. The use of standard hex bits allows for the use of an owner's existing bit collection. Also, as suggested, the invention eliminates the need to handle individual driver bits. Once the bits are loaded into a cartridge, cassette or cylinder, they need never be handled again, as they are removed only during use and then automatically returned for future use. This makes the device more enjoyable and reliable to use, as the desired driver bits are always available and can not be lost or misplaced.

Although the present invention has been described in some detail by way of illustration and example for purposes of clarity and understanding, it will, of course, be understood that various changes and modifications may be made in the form, details, and arrangements of the parts without departing from the scope of the invention set forth in the following claims. The claims appended hereto are meant to cover modifications and changes within scope and spirit of the present invention.

What is claimed is:

1. A self-loading bit driver tool comprising:
a handle that generally defines a predetermined axis;
a movable support member mounted on said handle for movement along a direction generally parallel to said axis between a proximate position closest to said handle and a remote position furthest from said handle;
a bit storage member for receiving and storing a plurality of driver bits, said bit storage member being removably supported on said movable support member and being adjustably positionable, in said remote position of said movable support member, to selectively and successively position each of the stored driver bits along said axis;
a barrel mounted on the remote side of said movable support member and being movable therewith and dimensioned to receive and support a bit driver during use of the tool; and
actuating means for moving a selected driver bit from said bit storage member into said barrel when said movable support member is moved to said proximate position and returning a bit driver within said barrel into said bit storage member when said movable support member is moved to said remote position.

2. A bit driver tool as defined in claim 1, wherein said movable support member is slidably mounted on said handle.

3. A bit driver tool member as defined in claim 1, wherein said handle includes an axial channel defining an opening at one axial end of said handle, and said movable support member includes an elongate slide bar or rod slidably receivable within said axial channel for moving said movable support member between said proximate and remote positions.

4. A bit driver tool member as defined in claim 3, wherein said movable support member includes a cradle on an axial end of said slide bar exposed exteriorly of said handle in both said proximate and remote positions, said cradle being configured and dimensioned to releasably receive said bit storage member.

5. A bit driver tool member as defined in claim 4, wherein said cradle defines a chamber having an opening for receiving and releasing said bit storage member by movements generally transverse to the direction of said predetermined axis.

6. A bit driver tool member as defined in claim 5, wherein said chamber is formed by two axially spaced walls.

7. A bit driver tool member as defined in claim, 6, wherein said walls are generally parallel and arranged in planes substantially normal to said axis.

8. A bit driver tool member as defined in claim 5, wherein said chamber is provided with axe opening dimensioned to allow said bit storage member to be inserted or removed from said chamber.

9. A bit driver tool member as defined in claim 5, further comprising means for rotatably mounting said bit storage member for rotation about said axis when received within said chamber.

10. A bit driver tool member as defined in claim 9, further comprising indexing means for indexing the positions of said bit storage member to a user when a bit is moved to a position aligned along or coextensive with said axis.

11. A bit driver tool member as defined in claim 10, wherein said indexing means comprises ball detent mechanism elements on said cradle and on said bit storage member.

12. A bit driver tool member as defined in claim 1, wherein said bit storage member comprises a rotating cylinder provided with a plurality of driver bit receiving bores each dimensioned to receive a driver bit.

13. A bit driver tool member as defined in claim 12, wherein, said cylinder is formed of a transparent material.

14. A bit driver tool member as defined in claim 13, wherein said transparent material comprises a clear acrylic plastic.

15. A bit driver tool member as defined in claim 12, wherein each bore in said chamber is open at both axial ends when supported in said cradle, the open remote ends being dimensioned to allow a bit to be axially removed from an associated bore and moved into said barrel.

16. A bit driver tool member as defined in claim 15, wherein the driver bits have hex cross sections and said bores have corresponding hex cross sections.

17. A bit driver tool member as defined in claim 15, wherein the open proximate ends of said chamber are dimensioned to prevent movements of bits downstream of said chamber into said handle.

18. A bit driver tool member as defined in claim 10, wherein said support member includes a viewing means for viewing a bit positioned along said axis so that a user can move a desired bit into said barrel for use.

19. A bit driver tool member as defined in claim 12, wherein six bit receiving bores are provided.

20. A bit driver tool member as defined in claim 12, further comprising retaining means for retaining said driver bits with said bores and for preventing said driver bits from inadvertently coming out of said bores during handling.

21. A bit driver tool member as defined in claim 20, wherein said retaining means comprises a magnet centrally positioned relative to said bores for generating a retaining magnetic field within said bores.

22. A bit driver tool member as defined in claim 1, wherein said handle is provided at a proximate axial end with a cavity for receiving a spare bit storage member.

23. A bit driver tool member as defined in claim 1, wherein said actuating means comprises an elongate push rod fixed at a proximate end to said handle and a remote end passing through said movable support member for axially displacing a bit from said bit storage member into said barrel when said support member is moved to said proximate position.

24. A bit driver tool member as defined in claim 23, further comprising a magnet at said push rod remote end for magnetically attracting a bit within said barrel for removing said driver bit and returning it to said bit storage member when said support member is moved to said remote position.
